(19) United States
(12) Patent Application Publication
(10) Pub. No.: US 2017/0111391 A1
(43) Pub. Date: Apr. 20, 2017

(54) ENHANCED INTRUSION PREVENTION SYSTEM

(71) Applicant: International Business Machines Corporation, Armonk, NY (US)

(72) Inventors: Chih-Wen Chao, Taipei (TW); Hsin-Yu Chuang, Taoyuan City (TW); Ming-Pin Hsueh, Taipei City (TW); Sheng-Wei Lee, Changhua City (TW)

(21) Appl. No.: 14/883,748

(22) Filed: Oct. 15, 2015

(51) Int. Cl. H04L 29/06

(52) U.S. Cl. CPC H04L 63/1491; H04L 63/1416

(57) ABSTRACT

As disclosed herein a method, executed by a computer, includes detecting, by an intrusion prevention system, intruder network traffic addressed to a computing device, creating a decoy virtual machine, and redirecting the intruder network traffic to the decoy virtual machine. The method further includes determining one or more attack characteristics of the intruder network traffic, and generating a new intruder signature corresponding to the attack characteristics. The method further includes validating the new intruder signature, and providing the new intruder signature to the intrusion prevention system. A computer system and computer program product corresponding to the above method are also disclosed herein.

### BACKGROUND

The present invention relates to intrusion prevention systems, and more particularly real-time intrusion analysis and signature generation for intrusion prevention systems.

An intrusion prevention system (IPS) is a network security appliance that monitors network operations for malicious activity. The main function of an IPS is to identify malicious activity with the intention of attempting to block and/or stop the malicious activity. Intrusion prevention systems are placed in-line between a computing environment and the network, and are able to actively prevent and/or block intrusions that are detected. When the IPS detects an intruder, the intruder is denied access to the computing environment (quarantined), and all additional traffic from the originator of the quarantined network packet may also be denied.

### SUMMARY

As disclosed herein a method, executed by a computer, includes detecting, by an intrusion prevention system, intruder network traffic addressed to a computing device, creating a decoy virtual machine, and redirecting the intruder network traffic to the decoy virtual machine. The method further includes determining one or more attack characteristics of the intruder network traffic, and generating a new intruder signature corresponding to the attack characteristics. The method further includes validating the new intruder signature, and providing the new intruder signature to the intrusion prevention system. A computer system and computer program product corresponding to the above method are also disclosed herein.

### BRIEF DESCRIPTION OF THE DRAWINGS

FIG. 1 is a functional block diagram depicting a computing environment, in accordance with at least one embodiment of the present invention;

FIG. 2 is a flowchart depicting an attack analysis method, in accordance with at least one embodiment of the present invention;

FIG. 3 depicts an example intruder signature data, in accordance with at least one embodiment of the present invention; and

FIG. 4 is a functional block diagram depicting various components of one embodiment of a computer suitable for executing the methods disclosed herein.

### DETAILED DESCRIPTION

In today's highly computerized world, the daily operation of corporations and activities of individuals are highly dependent on computers. Corporations rely on computers and computer applications to operate their business and to provide services to their customers. Individuals use computers to manage and maintain many aspects of their lives (e.g., communication, entertainment, shopping, banking, etc.). In general, we rely on computers to provide online banking and shopping applications, as well as for retaining an abundance of important, confidential, and personal information.

Providing secure computing environments is a high priority for service providers. Preventing unauthorized access (intrusions) to computing environments is an important part of system security. An intrusion prevention system (IPS) may be used to prevent intruders from gaining unauthorized access to computer systems containing applications and/or important information. Intrusion Prevention Systems are control devices that may sit in-line between a network and a computing environment. The IPS may monitor network traffic that is attempting to reach the computer system, and deny access to any identified intruder. The IPS may use intruder signatures to implement or enforce a particular security policy that determines what traffic is not allowed through. The policy may consist of hundreds or thousands of signatures (rules) designed to block known intruders (security risks) from gaining access to a computing environment. A signature may be a pre-configured and pre-determined attack pattern that may identify an intruder. Most of the rules are “deny” rules which block known intruders from gaining access to the computing environment. The rules are typically static and predetermined, meaning the rules are not identified or updated in real time.

When the IPS detects an intruder, the intruder is quarantined (denied access) without taking the opportunity to completely analyze the content and actions of the intruder. It has been determined that an intruder should be allowed access to a monitoring area where the content and actions of the intruder can be safely analyzed in real-time. The analysis may provide a better understanding of the tactics of the attack, resulting in a more complete signature (i.e., identifying characteristics of the intruder) and also enabling real-time updates to the IPS rules. The embodiments disclosed herein generally address the above-described problems.

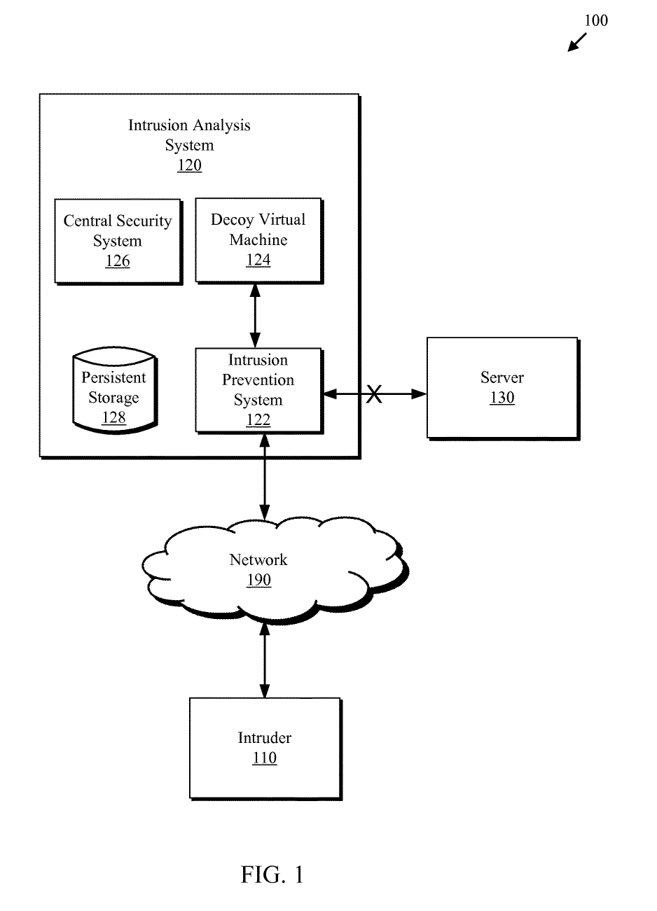

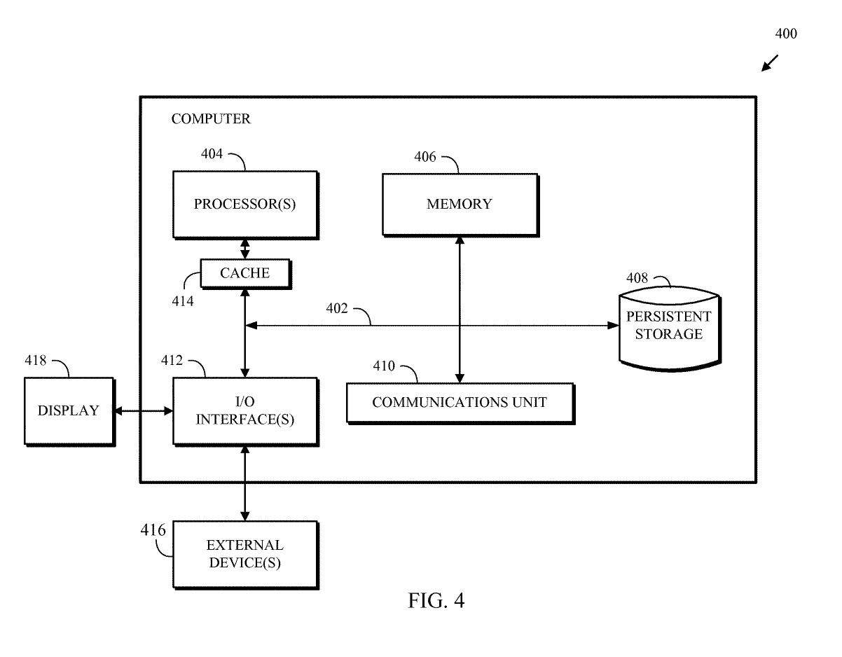

The present invention will now be described in detail with reference to the Figures. FIG. 1 is a functional block diagram depicting a computing environment 100, in accordance with an embodiment of the present invention. Computing environment 100 includes intruder 110, intrusion analysis system 120, and server 130. Intruder 110 and server 130 can include smart phones, tablets, desktop computers, laptop computers, specialized computer servers, or any other computer systems, known in the art, capable of communicating over network 190. In general, intruder 110 and server 130 are representative of any electronic devices, or combination of electronic devices, capable of executing machine-readable program instructions, as described in greater detail with regard to FIG. 4.

As depicted, intrusion analysis system 120 includes an intrusion prevention system 122, a decoy virtual machine 124, a central security system 126, and persistent storage 128. Intrusion analysis system 120 enables real-time analysis of intrusions (attacks) and creation of new intruder signature. A new intruder signature may be a more robust signature corresponding to a known intruder, or a signature corresponding to a newly identified intruder.

Intrusion prevention system (IPS) 122 may be a network security monitor provided as a hardware appliance or a software implementation. IPS 122 may sit in-line and monitor network for malicious activities (intruders). Monitoring may include comparing network traffic that is addressed to server 130 with known intruder signatures. A signature may be a pre-configured attack pattern that identifies previously detected attack characteristics corresponding to an intruder. In some embodiments, IPS 122 retrieves the signatures for comparison from persistent storage 128. In other embodiments, in an effort to enhance performance, the signatures for comparison are retained in random access memory (RAM).

IPS 122 allows traffic that is not determined to be a threat to continue to server 130. When IPS 122 identifies potentially threatening traffic, intrusion analysis system 120 may: (i) deny the potentially threatening traffic access to server 130; (ii) create decoy virtual machine 124, (iii) redirect the potentially threatening traffic to decoy virtual machine 124; (iv) determine the attack characteristics; (v) generate a new intruder signature; (vi) validate the new intruder signature; and (vii) provide the new (more robust) intruder signature to IPS 122.

Decoy virtual machine 124 (hereinafter decoy 124) may be an environment created (e.g., cloned) to imitate server 130, providing intruder 110 with the same experience on decoy 124 as would have been experienced on server 130. However, decoy 124 is isolated from server 130, preventing intruder 110 from harming server 130. Use of decoy 124 enables analysis of the attack and collection of attack characteristics corresponding to intruder 110. In some embodiments, decoy 124 stores observed attack characteristics on persistent storage 128. In other embodiments, persistent storage 128 contains applications and databases that are part of the decoy 124 execution environment.

Central security system 126 may use the collection of attack characteristics to create a new or more robust signature that may more consistently detect attacks from intruder 110 or other intruders (not shown). After successful verification, central security system 126 provides the new signature to IPS 122 for inclusion in the network traffic monitoring operation.

Intruder 110 may be any client that communicates with server 130 over network 190. Server 130 may be a web server, an application server, or any computing device capable of receiving internet traffic over network 190. Server 130 may provide a public online web application (e.g., a banking application, an auction site, a video streaming site, or the like), a corporate internal services (e.g., a billing application, human resources data retention, internal email, and the like), or any other services capable of being run on a computing device. In the depicted embodiment, intrusion analysis system 120 and server 130 are separate computers. In other embodiments, intrusion analysis system 120 and server 130 coexist on a single computer.

Persistent storage 128 may be any non-volatile storage media known in the art. For example, persistent storage 128 can be implemented with a tape library, optical library, one or more independent hard disk drives, or multiple hard disk drives in a redundant array of independent disks (RAID). Similarly, data on persistent storage 128 may conform to any suitable storage architecture known in the art, such as a file, a relational database, an object-oriented database, and/or one or more tables.

Intruder 110, intrusion analysis system 120, server 130, and other electronic devices (not shown) communicate over network 190. Network 190 can be, for example, a local area network (LAN), a wide area network (WAN) such as the Internet, or a combination of the two, and include wired, wireless, or fiber optic connections. In general, network 190 can be any combination of connections and protocols that will support communications between intruder 110, intrusion analysis system 120, and server 130 in accordance with an embodiment of the present invention.

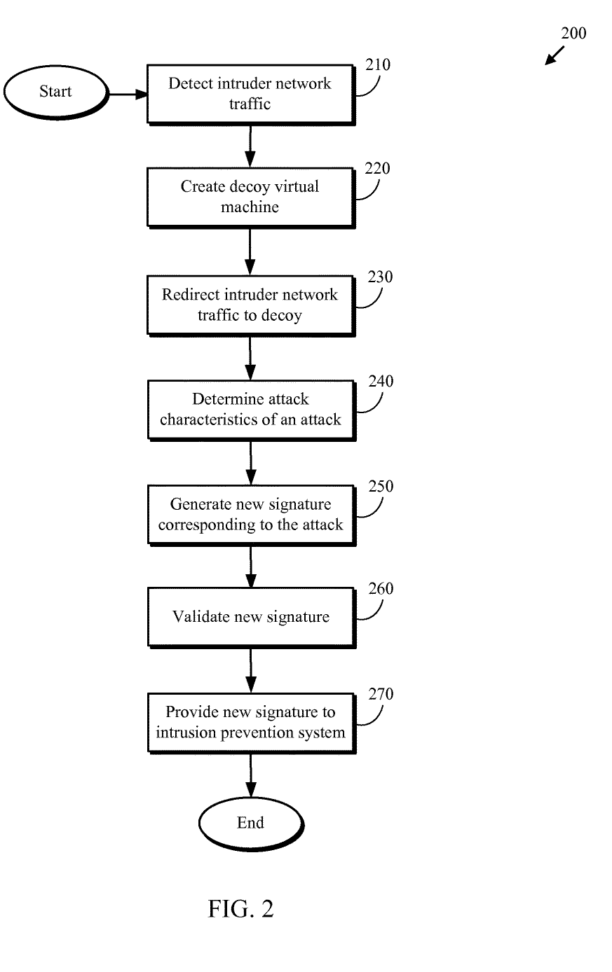

FIG. 2 is a flowchart depicting an attack analysis method 200, in accordance with at least one embodiment of the present invention. As depicted, attack analysis method 200 includes detecting (210) intruder network traffic, creating (220) a decoy virtual machine, redirecting (230) intruder network traffic to a decoy, determining (240) attack characteristics of an attack, generating (250) a new signature, validating (260) a new signature, and providing (270) a new signature to an intrusion prevention system. Attack analysis method 200 enables real-time analysis of attack characteristics as well as real-time generation and availability of new (updated) signatures for use by an intrusion protection system (IPS) (e.g., IPS 122).

Detecting (210) intruder network traffic may include intrusion analysis system 120 monitoring incoming network traffic for a potential attack from an intruder. Network traffic may be monitored by inspecting one or more network packets and comparing the characteristics in the one or more packets with characteristics identified in existing signatures. Signatures may be either atomic signatures or stateful signatures. Atomic signatures require analysis of only a single packet to identify a potential attack. Stateful signatures may require the analysis of multiple packets to identify a potential attack. For example, a signature may identify a string to be detected (e.g., “/etc/passwd”) and the string could be split across multiple packets. To successfully detect the string, IPS 122 may need to retain or remember information between analysis of packets. Intrusion analysis system 120 may consume system memory to maintain state between the analysis operations of each of the multiple packets.

Intrusion analysis system 120 may detect potential intruder network traffic by identifying a known malicious source IP address or identifying traffic payload that is attempting to access sensitive data. Additionally, intrusion analysis system 120 may also monitor system events occurring on server 130 and detect a suspicious system call pattern that may cause a service to become unavailable (e.g., the service is down).

Creating (220) a decoy virtual machine may include intrusion analysis system 120 determining the vulnerabilities being targeted (e.g., attacked) by the intruder network traffic. Intrusion analysis system 120 may then create a decoy virtual machine (e.g., decoy 124), including at least the determined vulnerabilities, in location that is isolated from the target of the intruder network traffic (e.g., server 130). In some embodiments, decoy 124 is a complete duplicate (clone) of server 130. In other embodiments, cloning sever 130 is not practical, and decoy 124 is customized to be vulnerable to the attack characteristics identified in determining operation 210.

Redirecting (230) intruder network traffic to a decoy may include intrusion analysis system 120 denying the intruder network traffic access to server 130. Intrusion analysis system 120 may secretly (i.e., without intruder 110 knowing) redirecting the intruder network traffic to decoy 124. In some embodiments, intrusion analysis system 120 captures and retains a copy of the redirected intruder network traffic on persistent storage 128.

Determining (240) attack characteristics of an attack may include intrusion analysis system 120 allowing the attack to process on decoy 124. While the attack occurs, intrusion analysis system 120 may monitor the attack and perform a detailed analysis to obtain identifying characteristics of the attack. Attack characteristics may include, but are not limited to, the source media access control (MAC) address, source IP address, unique information in the packet headers, and unique payload content. In some instances, the attack may embed a secret backdoor enabling an attack from a second attacker via the back door. An IP reputation list (IPR) may be used to determine if the any attacker is a new or known attacker. The IPR may be a collection of known IP addresses including a ranking indicating the reputation of each IP address. Each time an IP address is identified as malicious, the reputation of the identified IP address may be adjusted. In some embodiments, the IPR contains only suspected malicious (dangerous) IP addresses and indicates varying degrees of bad reputations. In other embodiments, the IPR contains all known IP addresses, and indicates both good and bad reputations. Analysis may continue until intrusion analysis system 120 indicates the attack has run to completion.

Generating (250) a new signature may include intrusion analysis system 120 collecting all of the attack characteristics identified during determining operation 240, and organizing all of the collected attack characteristics in a predefined format. In some embodiments, central security system 126 generates the new signature. In other embodiments, a signature generation module is configured to generate the new signature. The new signature may be a combination of an existing intruder signature and at least one of the identified attack characteristics. Alternatively, the identified attack characteristics may result a new, nonexistent, signature.

In some embodiments, the signature is an (object oriented programming) object with each attack characteristic defined as an attribute of the object. The object may have methods to create, access, and cleanup objects and attributes (characteristics). In other embodiments, a signature is a record with each attack characteristic stored at a specific location (offset) within the record. Some attacks may diverge (e.g., enabling a back door to allow a second attacker) and result in the generation of multiple new signatures. The newly created signature may be stored on persistent storage 128 in a database, a file, or any other format capable of storing the new signature. In some embodiments, the new signature is compared with an existing signature, and if the two signatures are the same, then no additional attack characteristics were identified. If there are differences between the new and existing signatures, then processing continues with the validating operation 260. Otherwise, attack analysis method 200 terminates.

Validating (260) a new signature may include intrusion analysis system 120 retrieving (e.g., from persistent storage 128) a captured copy of the intruder network traffic and replaying (e.g., rerunning) the intruder network traffic on decoy 124. If an IPS (e.g., IPS 122) detects the attack using the new signature, the new signature may be considered a valid signature. In some embodiments, the validation includes verifying (confirming) that the new signature detects not only the existing attack characteristics, but also any new characteristics included in the new signature. In some embodiments, intrusion analysis system 120 retains failed signatures in persistent storage 128 for further analysis. Additionally, one or more administrators may be notified of the failure via email and/or a system alert. If the validation fails, then attack analysis method 200 terminates.

Providing (270) a new signature to an intrusion prevention system may include intrusion analysis system 120 making the new signature available to IPS 122 in real-time. The new signature may be a replacement (updated signature) for an existing signature or the new signature may be a new entry for IPS 122. In some embodiments, IPS 122 receives an alert from central security system 126 indicating that a new signatures are available, and IPS 122 retrieves and deploys the new signature. In other embodiments, central security system 126 deploys the new signature to IPS 122.

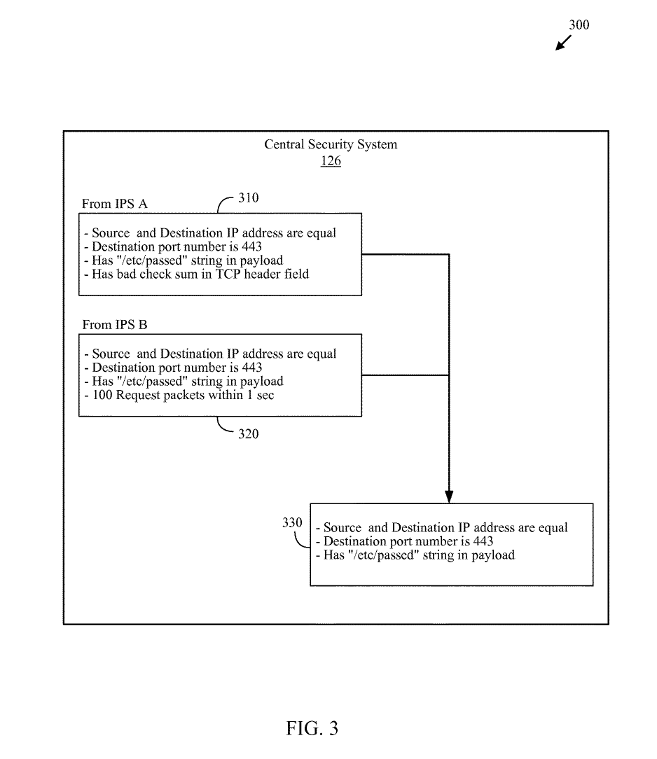

FIG. 3 depicts example 300 of intruder signature data, in accordance with at least one embodiment of the present invention. Example 300 includes example signature sets 310 and 320 from two different IPS appliances, IPS A and IPS B (not pictured). Both signature sets (310 and 320) were received as a result of system attacks exhibiting the same attack characteristic—resulting in a HTTP server going down.

In example 300, signature set 310 is existing data retained by central security system 126 from a previous analysis operation. Signature set 320 is signature information that has just been received from IPS B as the result of a recent attack. Upon receiving signature set 320, central security system 126 compares the information included in all signatures exhibiting the same attack characteristic to determine what is common with all signatures. As a result of the analysis, result signature set 330 is produced. Result signature set 330 contains only the elements in common between signature set 310 and signature set 320. A signature including only the elements in result signature set 330 would detect the attack that produced both signature set 310 and signature set 320. As attackers advance, they may alter (e.g., disguise) the attack, however parts of the attack may remain constant. Analyzing numerous attacks and detecting the constant elements of the attacks allows refinement of a signature.

In the depicted example, there are only two signature sets (310 and 320) with a limited number of elements. However, in an active intrusion analysis system, there may be several (perhaps thousands) signature sets, with many elements. As the number of detected and analyzed attacks increase, and the number of signature sets increases, the accuracy of a signature may increase and become more refined. The more refined a signature becomes, the more likely it is that an attack will be recognized and detected prior to any damage occurring.

FIG. 4 depicts a functional block diagram of components of a computer system 400, which is an example of systems such as intruder 110 and server 130 within computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Intruder 110, intrusion analysis system 120, and server 130 include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., attack analysis method 200 are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of intruder 110, intrusion analysis system 120, and server 130. In these examples, communications unit 410 includes one or more network interface cards. Communications unit 410 may provide communications through the use of either or both physical and wireless communications links. Program instructions and data used to practice embodiments of attack analysis method 200 may be downloaded to persistent storage 408 through communications unit 410.

I/O interface(s) 412 allows for input and output of data with other devices that may be connected to each computer system For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
detecting, by an intrusion prevention system, intruder network traffic addressed to a computing device;
creating a decoy virtual machine;
redirecting the intruder network traffic to the decoy virtual machine;
determining one or more attack characteristics of the intruder network traffic;
generating a new intruder signature corresponding to the attack characteristics;
validating the new intruder signature; and
providing the new intruder signature to the intrusion prevention system.

2. The method of claim 1, wherein the decoy virtual machine is customized to be vulnerable to the attack characteristics.

3. The method of claim 1, wherein the decoy virtual machine is isolated from the computing device.

4. The method of claim 1, wherein the intruder network traffic originates from a dangerous IP address, or attempts to access sensitive data.

5. The method of claim 1, wherein the attack characteristics comprise a suspect system call pattern or take down a service.

6. The method of claim 1, wherein the new intruder signature comprises a combination of an existing intruder signature and at least one of the attack characteristics.

7. The method of claim 1, wherein validating the new intruder signature comprises replaying the intruder network traffic on the decoy virtual machine and confirming that the intrusion prevention system detects the intruder network traffic using the new intruder signature.

8. A computer program product comprising:
one or more computer readable storage media and program instructions stored on the one or more computer readable storage media, the program instructions comprising instructions to:
detect, by an intrusion prevention system, intruder network traffic addressed to a computing device;
create a decoy virtual machine;
redirect the intruder network traffic to the decoy virtual machine;
determine one or more attack characteristics of the intruder network traffic;
generate a new intruder signature corresponding to the attack characteristics;
validate the new intruder signature; and
provide the new intruder signature to the intrusion prevention system.

9. The computer program product of claim 8, wherein the decoy virtual machine is customized to be vulnerable to the attack characteristics.

10. The computer program product of claim 8, wherein the decoy virtual machine is isolated from the computing device.

11. The computer program product of claim 8, wherein the intruder network traffic originates from a dangerous IP address, or attempts to access sensitive data.

12. The computer program product of claim 8, wherein the attack characteristics comprise a suspect system call pattern or take down a service.

13. The computer program product of claim 8, wherein the new intruder signature comprises a combination of an existing intruder signature and at least one of the attack characteristics.

14. The computer program product of claim 8, wherein the program instructions to validate the new intruder signature comprise instructions to replay the intruder network traffic on the decoy virtual machine and confirm that the intrusion prevention system detects the intruder network traffic using the new intruder signature.

15. A computer system comprising:
one or more computer processors;
one or more computer readable storage media;
program instructions stored on the computer readable storage media for execution by at least one of the computer processors, the program instructions comprising instructions to:
detect, by an intrusion prevention system, intruder network traffic addressed to a computing device;
create a decoy virtual machine;
redirect the intruder network traffic to the decoy virtual machine;
determine one or more attack characteristics of the intruder network traffic;
generate a new intruder signature corresponding to the attack characteristics;
validate the new intruder signature; and
provide the new intruder signature to the intrusion prevention system.

16. The computer system of claim 15, wherein the decoy virtual machine is customized to be vulnerable to the attack characteristics.

17. The computer system of claim 15, wherein the decoy virtual machine is isolated from the computing device.

18. The computer system of claim 15, wherein the intruder network traffic originates from a dangerous IP address, or attempts to access sensitive data.

19. The computer system of claim 15, wherein the attack characteristics comprise a suspect system call pattern or take down a service.

20. The computer system of claim 15, wherein the program instructions to validate the new intruder signature comprise instructions to replay the intruder network traffic on the decoy virtual machine and confirm that the intrusion prevention system detects the intruder network traffic using the new intruder signature.
